(19) United States
(12) Patent Application Publication
(10) Pub. No.: US 2014/0140885 A1
(43) Pub. Date: May 22, 2014

(54) Hydrogen storage alloy and negative electrode and Ni-metal hydride battery employing same

(71) Applicants: Kwo Young, Troy, MI (US); Taihei Ouchi, Oakland Township, MI (US); Jean Nei, Southgate, MI (US)

(72) Inventors: Kwo Young, Troy, MI (US); Taihei Ouchi, Oakland Township, MI (US); Jean Nei, Southgate, MI (US)

(21) Appl. No.: 13/694,299

(22) Filed: Nov. 16, 2012

(51) Int. Cl. H01M 4/38

(52) U.S. Cl. CPC H01M 4/383
USPC 420/422; 420/441

(57) ABSTRACT

A hydrogen storage alloy having a higher electrochemical hydrogen storage capacity than that predicted by the alloy's gaseous hydrogen storage capacity at 2 MPa. The hydrogen storage alloy may have an electrochemical hydrogen storage capacity 5 to 15 times higher than that predicted by the maximum gaseous phase hydrogen storage capacity thereof. The hydrogen storage alloy may be selected from alloys of the group consisting of A₂B, AB, AB₂, AB₃, A₂B₇, AB₅ and AB₉. The hydrogen storage alloy may further be selected from the group consisting of: a) Zr(VₓNi_{4.5-x}); wherein 0<x≦0.5; and b) Zr(VₓNi_{3.5-x}); wherein 0<x≦0.9.

### FIELD OF THE INVENTION

The present invention relates generally to Ni-metal hydride batteries and more specifically to the negative electrodes there of. Most specifically, this invention relates to a hydrogen storage material for use in the negative electrodes of a Ni-metal hydride battery. The alloys have electrochemical capacities which are higher than predicted by their gaseous capacities at 2 MPa of pressure. The hydrogen storage alloy may be selected from alloys of the group consisting of A₂B, AB, AB₂, AB₃, A₂B₇, AB₅ and AB₉.

### BACKGROUND OF THE INVENTION

Recent increases in rare earth metal prices have put the nickel/metal hydride (Ni/MH) battery industry in an economically disadvantageous position compared with rival battery technologies. Transition metal-based AB₂ alloys are a potential candidate to replace the rare earth-based AB₅ metal hydride (MH) alloys used for the negative electrode in Ni/MH batteries. Unfortunately, up to now, AB₂ MH alloys have had lower high-rate dischargeability (HRD) than AB₅ and A₂B₇ alloys, which have higher B/A ratios and consequently higher densities of metallic inclusions embedded in the surface oxide. Therefore, AB2 MH alloys have not been suitable for applications requiring very high power densities (>2000 W/kg), such as hybrid electric vehicles. The reason for the lower B/A ratio in Ti and Zr-based AB₂ MH alloys is the relatively weak proton affinities of Ti (heat of hydride formation (ΔHₕ=−123.8 kJ/mol H₂) and Zr (ΔHₕ=−162.8 kJ/mol H₂) compared to that of La (ΔHₕ=−209.2 kJ/mol H₂). Thus, smaller amounts of B elements are needed to lower the ΔHₕ of the alloy to a range that is suitable for room temperature Ni/MH application (−30 to −45 kJ/mol). In order to increase the HRD of Ti and Zr-based MH alloys, alloys with higher B/A ratios are of great interest, such as TiNi₉ and ZrNi₅. While the hydrogen storage characteristics of TiNi₉ have not been reported, the reported storage capacity of ZrNi₅ is only about 0.15 wt. % (ZrNi₅H_{0.57}), 0.19 wt. % (ZrNi₅H_{0.72}), and 0.22 wt. % (ZrNi5H0.86) at 2.0 MPa, 10 MPa, and 0.9 GPa H₂ pressure respectively. Unfortunately, the unit cell of ZrNi₅ is too small to accommodate larger amounts of hydrogen storage. Substitutions with larger elements such as La (in the A-site) and Al (in the B-site) were investigated previously by electrochemical charging and the storage capacities were still very low: 0.0151 wt. % (Zr_{0.8}La_{0.2}Ni₅H_{0.059}) and 0.0013 wt. % (ZrNi_{4.8}Al_{0.2}H_{0.005}). By incorporating an additional AB₃ phase, Co-substituted ZrNi5 alloy showed a substantial improvement in hydrogen storage capacity (0.34 wt. %, ZrNi₂Co₃H_{1.31}). However, this capacity is still too low to be considered for the negative electrode in Ni/MH battery applications. Other elements that have been used to substitute Ni in ZrNi₅ included Sb, Bi, Al+Li, In, Sn, In+As, In+Bi, Zn+Te, Cd+Te, and Zn, but the hydrogen storage capacities were not disclosed.

Vanadium has been regarded as a hydride forming element in the development of multi-phase disordered AB₂ MH alloys. The contribution of V to the hydrogen storage properties of AB₂ MH alloys was reported previously and can be summarized as follows. Vanadium increases the maximum hydrogen storage capacity of the alloy, but the reversible hydrogen storage capacity decreases due to the increase in hydrogen-metal bond strength. In another effort to improve the storage capacity of Zr₇Ni₁₀ MH alloy, V was chosen to be the first modifying element, and the results were very promising: the full electrochemical capacity increased from 204 mAh/g in Ti_{1.5}Zr_{5.5}Ni₁₀ to 359 mAh/g in Ti_{1.5}Zr_{5.5}V_{2.5}Ni_{7.5}.

Thus there is a need in the art for a metal hydride storage alloy for the negative electrodes of Ni/MH batteries that does not contain significant quantities of rare earth elements and still has useful high-rate dischargeability (HRD) and reasonable storage capacity.

### SUMMARY OF THE INVENTION

The present invention is a hydrogen storage alloy which has a higher electrochemical hydrogen storage capacity than that predicted by the alloy's gaseous hydrogen storage capacity at 2 MPa. The hydrogen storage alloy may have an electrochemical hydrogen storage capacity 5 to 15 times higher than that predicted by the maximum gaseous phase hydrogen storage capacity thereof. The hydrogen storage alloy may be selected from alloys of the group consisting of A₂B, AB, AB₂, AB₃, A₂13₇, AB₅ and AB₉. The hydrogen storage alloy may be elected from the group consisting of: a) Zr(VₓNi_{4.5-x}); wherein 0<x≦0.5; and b) Zr(VₓNi_{3.5-x}); wherein 0<x≦0.9. When the hydrogen storage alloy has the formula: Zr(VₓNi_{4.5-x}), x may be: 0.1≦x≦0.5; 0.1≦x≦0.3; 0.3≦x≦0.5; 0.2≦x≦0.4. Also, x may be any of 0.1; 0.2; 0.3; 0.4; or 0.5.

The hydrogen storage alloy may further include one or more elements selected from the group consisting Mn, Al, Co, and Sn in an amount sufficient enough to enhance one or both of the discharge capacity and the surface exchange current density versus the base alloy.

When the hydrogen storage alloy has the formula: Zr(VₓNi_{4.5-x}), it may have one or more properties such as: 1) a bulk proton diffusion coefficient greater than 4×10⁻¹⁰ cm² s⁻¹; 2) a high rate dischargeability of at least 75%; 3) an open circuit voltage of at least 1.25 volts; and an exchange current of at least 24 mA g⁻¹.

The present invention further includes a negative electrode for a Ni-metal hydride battery formed using the inventive alloys and a Ni-metal hydride battery formed using said electrode.

### BRIEF DESCRIPTION OF THE FIGURES

FIG. 1 is a plot of the XRD patterns using Cu—K as the radiation source for alloys YC#1 to YC#6;

FIG. 2 plots the unit cell volume of the m-Zr2Ni7 phase as a function of V-content in the alloy;

FIG. 3 plots the phase abundances as functions of V-content in the alloy;

FIGS. 4a-4f are SEM back-scattering electron images for alloys YC#1 (a), YC#2 (b), YC#3 (c), YC#4 (d), YC#5 (e), and YC#6 (f), respectively;

FIGS. 5a-5b plot the PCT isotherms measured at 30° C. for alloys YC#1-YC#3 (5a) and YC#4-YC#6 (5b);

FIG. 6a plots the half-cell discharge capacities of the six alloys measured at 4 mA g-1 versus cycle number during the first 13 cycles;

FIG. 6b plots the high-rate dischargeabilities of the six alloys versus cycle number during the first 13 cycles;

FIG. 7 plots the open circuit voltage vs. pressure at the mid-point of PCT desorption isotherm measured at 30° C. from two series of prior art off-stoichiometric MH alloys (AB₂ and AB₅);

FIG. 8 plots the full discharge capacities at the 10th cycle (open symbol) and open circuit voltage (solid symbol) as functions of V-content in the alloy for the six alloys YC#1-YC#6;

FIG. 9 plots the measured electrochemical discharge capacity vs. calculated electrochemical discharge capacity converted from gaseous phase hydrogen storage measurements using the conversion 1 wt. % of hydrogen storage=268 mAh g−1;

FIG. 10a is a plot of the XRD patterns using Cu—K as the radiation source for alloys YC#7 to YC#11;

FIG. 10b is a plot of the XRD patterns using Cu—K as the radiation source for alloys YC#12 to YC#16; and

FIG. 11 is photomicrograph of sample YC#12, and is exemplary of the photomicrographs of all of the samples YC#7-YC#16.

### DETAILED DESCRIPTION OF THE INVENTION

The present inventors have discovered hydrogen storage alloys that have electrochemical hydrogen storage capacities which are higher than predicted by their respective gaseous hydrogen storage capacities at 2 Mpa of pressure. The hydrogen storage alloys may have electrochemical hydrogen storage capacities 5 to 15 times higher than that predicted by the maximum gaseous phase hydrogen storage capacity thereof.

The hydrogen storage alloy may be any alloy selected from alloys of the group consisting of A₂B, AB, AB₂, AB₃, A₂B₇, AB₅ and AB₉.

The inventors believe that the electrochemical discharge capacity is higher than the capacity obtained from gaseous phase measurement due to the synergetic effects of secondary phases present in the present, un-annealed alloys. While not wishing to be bound by theory, the inventors believe that the secondary phases in the present alloys act as catalysts to reduce the hydrogen equilibrium pressure in the electrochemical environment and increase the storage capacity.

The term “synergetic effect” is used herein to describe the increase in discharge capacity or high rate dischargeability (HRD) of the main phase in the presence of secondary phases. The synergetic effect arises as a result of the multi-phase nature, which provides various properties that together contribute positively to the overall performance. Moreover, the presence of secondary phases offers more catalytic sites in the microstructure for gaseous phase and/or electrochemical hydrogen storage reactions. For example, the secondary phases may have too high of a hydrogen equilibrium pressure and they may not absorb any considerable amount of hydrogen; however, they may act as a catalyst for hydrogen storage of the main phase. The abundance of the secondary phase is not as important as the interface area affected by the synergetic effect. That is, the amount of surface interface between the storage phase(s) and the catalytic secondary phase(s). Therefore, both the interface area and the penetration depth of the synergetic effect are crucial for maximizing the advantages of the present invention, such as higher storage capacity, higher bulk diffusion, and other electrochemical properties. The penetration depth may be estimated by dividing the improvement in various properties by the interface area from scanning electron micrographs. Herein after are specific examples of alloys that correspond to individual embodiments of the present invention.

### EXAMPLE 1

### ZrVₓNi_{4.5-x}

The present invention comprises the use of V as a modifying element to improve the electrochemical properties of ZrNi5 alloy. In order to improve the high-rate performance of the transition metal-based metal hydride alloys, a series of ZrVₓNi_{4.5-x} (x=0.0, 0.1, 0.2, 0.3, 0.4, and 0.5) ternary metal hydride alloys with high Ni-content were studied. The main phase(s) of the alloy evolves from ZrNi₅ and cubic Zr₂Ni₇ to monoclinic Zr₂Ni₇, ZrNi₅ and ZrNi₉, and then finally to monoclinic Zr₂Ni₇ only with increases in V-content. The secondary phase(s) evolves from monoclinic Zr₂Ni₇ and ZrNi₉ to cubic Zr₂Ni₇ and VNi₃ and then to VNi₂. PCT results show incomplete hydriding using the current set-up (up to 1.1 MPa), low maximum gaseous phase hydrogen storage capacities (≦0.075 wt. %, 0.05 H/M), and large hysteresis. The maximum gaseous phase storage capacity decreases, in general, with the increase in V-content. In the half-cell test, 5 to 15 times higher equivalent hydrogen storage capacities (up to 0.42 H/M) compared to the maximum gaseous phase capacities are observed. The equivalent hydrogen pressure during discharge was estimated from the open circuit voltage by both the Nernst equation and an empirical formula established from MH alloys that do not have clear plateaus in their PCT isotherms. The resulting hydrogen storage capacities are much lower than those observed from the gaseous phase study. Two hypotheses are raised to explain the lowering of equilibrium pressure: the easily activated surface and the synergetic effect from the secondary phases in the electrochemical environment. The bulk proton transport properties of the alloys in the current study are superior to any other MH alloys studied previously. The highest bulk diffusion coefficient obtained is 6.06×10⁻¹⁰ cm² s⁻¹from the base alloy ZrNi_{4.5}, which is more than double of the coefficient for the currently used AB₅ alloy (2.55×10⁻¹⁰ cm² s⁻¹). Although the discharge capacity (≦177 mAh g⁻¹) and the surface exchange current density are lower than the commercially used AB₅ alloy, these properties can be further optimized by introducing other modifying elements, such as Mn, Al, and Co.

### Experimental Setup

Arc melting was performed under a continuous argon flow with a non-consumable tungsten electrode and a water-cooled copper tray. Before each run, a piece of sacrificial titanium underwent a few melting-cooling cycles to reduce the residual oxygen concentration in the system. Each 12 g ingot was re-melted and turned over a few times to ensure uniformity in chemical composition. The chemical composition of each sample was examined by a Varian Liberty 100 inductively-coupled plasma (ICP) system. A Philips X'Pert Pro x-ray diffractometer (XRD) was used to study the microstructure, and a JEOL-JSM6320F scanning electron microscope (SEM) with energy dispersive spectroscopy (EDS) capability was used to study the phase distribution and composition. The gaseous phase hydrogen storage characteristics for each sample were measured using a Suzuki-Shokan multi-channel pressure-concentration-temperature (PCT) system. In the PCT analysis, each sample was first activated by a two hour thermal cycle between 300° C. and room temperature at 2.5 MPa H₂ pressure. The PCT isotherm at 30° C. was then measured.

Six alloys with V partially replacing Ni in various amounts (ZrVₓNi_{4.5-x}, x=0.0, 0.1, 0.2, 0.3, 0.4, and 0.5) were prepared by arc melting. A B/A ratio of 4.5 was chosen deliberately to take advantage of the large solubility range of the ZrNi₅ phase as shown in the Zr—Ni binary phase diagram. The design compositions and the ICP results are summarized in Table 1.

TABLE 1

| | | Zr (at. %) | Ni (at. %) | V (at. %) | (V + Ni)/Zr | Formula | Formula wt. |
|---|---|---|---|---|---|---|---|
| YC#1 | Design | 18.2 | 81.8 | 0 | 4.5 | ZrNi_{4.5} | 355.34 |
| | ICP | 18.2 | 81.8 | 0 | | | |
| YC#2 | Design | 18.2 | 80 | 1.8 | 4.5 | ZrV_{0.1}Ni_{4.4} | 354.57 |
| | ICP | 18.2 | 80 | 1.8 | | | |
| YC#3 | Design | 18.2 | 78.2 | 3.6 | 4.5 | ZrV_{0.2}Ni_{4.3} | 353.79 |
| | ICP | 17.8 | 78.5 | 3.7 | | | |
| YC#4 | Design | 18.2 | 76.4 | 5.4 | 4.5 | ZrV_{0.3}Ni_{4.2} | 353.02 |
| | ICP | 18 | 76.5 | 5.4 | | | |
| YC#5 | Design | 18.2 | 74.6 | 7.3 | 4.5 | ZrV_{0.4}Ni_{4.1} | 352.24 |
| | ICP | 17.9 | 74.7 | 7.4 | | | |
| YC#6 | Design | 18.2 | 72.7 | 9.1 | 4.5 | ZrV_{0.5}Ni_{4.0} | 351.47 |
| | ICP | 18.1 | 72.9 | 9 | | | |

As can be seen, the compositions determined by ICP are very close to the design values. The ingots were not annealed in order to preserve the secondary phases, which may be beneficial to the electrochemical properties. Formulas in the format of Zr(V, Ni)_{4.5} and associated formula weights are also included in Table 1.

### XRD Structure Analysis

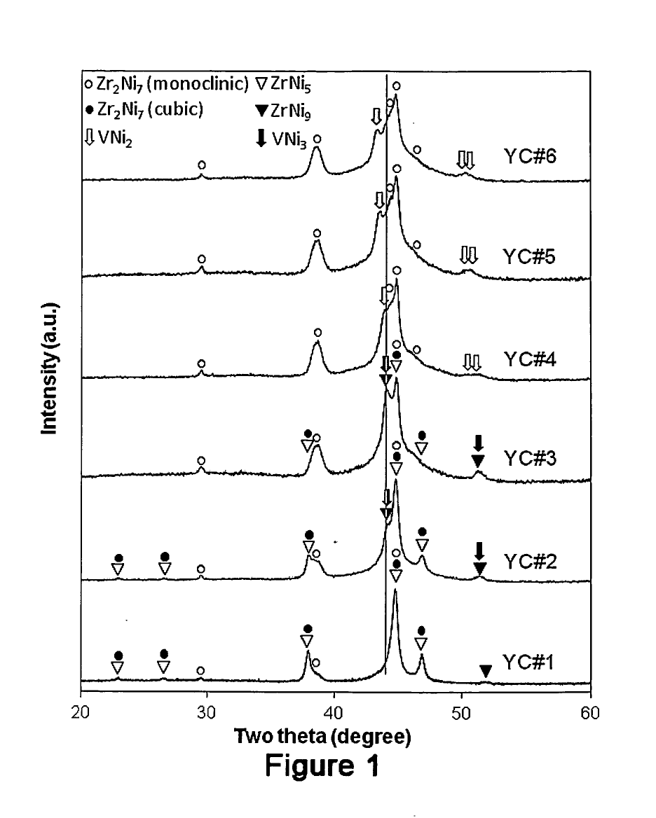

FIG. 1 is a plot of the XRD patterns using Cu—K as the radiation source for alloys YC#1 to #6. The vertical line is to illustrate the shifting of the ZrNi9 and VNi2 peaks to lower angles. Five structures can be identified: a monoclinic Zr₂Ni₇ (m-Zr₂Ni₇) (reference symbol ∘), a cubic Zr₂Ni₇ (c-Zr₂Ni₇) (reference symbol •), a cubic ZrNi₅ (reference symbol ∇), a cubic ZrNi₉ (reference symbol ▾), and an orthorhombic VNi₂ phase (reference symbol [symbol] ). The first structure, a stable structure of Zr₂Ni₇ after annealing, is monoclinic with lattice constants a=4.698 Å, b=8.235 Å, c=12.193 Å, b=95.83° and unit cell volume=469.3 Å³. The second structure, a metastable structure of Zr₂Ni₇, is cubic with lattice constant a=6.68 Å. An orthorhombic Zr₂Ni₇ phase has been reported previously but was not observed in the current study. Hf₂Co₇ is a similar alloy that contains this stable orthorhombic phase. The third structure, a ZrNi₅ cubic structure, is AuBe₅-type. Its reported lattice constant a varies slightly among different groups, averaging about 6.701. The fourth structure, the ZrNi₉ phase, does not exist in the Zr—Ni binary phase diagram and has not been reported before. However, a similar alloy TiNi₉, which was also not seen in the binary phase diagram, was reported to have a cubic structure with lattice constant a=3.56 Å. The fifth structure, an orthorhombic VNi₂ phase with a MoPt₂ structure, has a diffraction pattern with peaks overlapping with those of a simple cubic structure, such as ZrNi₅, with the major difference being a splitting of the (130) and (002) reflections near 50°. In addition, there is a VNi₃ (reference symbol [symbol] ) phase found in EDS analysis that was not identified in XRD analysis due to the complete overlapping of its pattern with the diffraction patterns of ZrNi₉.

Lattice constants of all five phases were calculated from the XRD patterns and are listed in Table 2.

TABLE 2

| | YC#1 | YC#2 | YC#3 | YC#4 | YC#5 | YC#6 |
|---|---|---|---|---|---|---|
| m-Zi₂Ni_{7,} a (Å) | 4.651 | 4.668 | 4.711 | 4.748 | 4.751 | 4.747 |
| m-Zi₂Ni_{7,} b (Å) | 8.233 | 8.245 | 8.366 | 8.406 | 8.442 | 8.406 |
| m-Zi₂Ni_{7,} c (Å) | 12.003 | 11.902 | 12.042 | 12.113 | 12.25 | 12.331 |
| m-Zi₂Ni_{7,} b (°) | 93.39 | 92.93 | 92.98 | 92.65 | 93.11 | 93.89 |
| m-Zi₂Ni₇, Vol. | 458.8 | 457.5 | 474 | 482.9 | 490.6 | 490.9 |
| (Å³) | | | | | | |
| c-Zi₂Ni_{7,} a (Å) | 6.701 | 6.701 | 6.703 | | | |
| ZrNi_{5,} a (Å) | 6.72 | 6.728 | 6.738 | | | |
| ZrNi_{9,} a (Å) | 3.527 | 3.55 | 3.555 | | | |
| VNi_{2,} a (Å) | | | | 2.562 | 2.602 | 2.614 |
| VNi_{2,} b (Å) | | | | 7.505 | 7.6 | 7.666 |
| VNi_{2,} c (Å) | | | | 3.468 | 3.433 | 3.399 |
| VNi₂, Vol. | | | | 66.68 | 67.89 | 68.11 |
| (Å³) | | | | | | |
| m-Zr₂Ni₇ % | 6.2 | 32.3 | 63.2 | 72.6 | 71.1 | 70.4 |
| c-Zr₂Ni₇ % | 43.9 | 7.6 | 4.5 | 0 | 0 | 0 |
| ZrNi₅ % | 43 | 25 | 4 | 0 | 0 | 0 |
| ZrNi₉/VNi₃ % | 6.9 | 35.1 | 28.3 | 0 | 0 | 0 |
| VNi₂ % | 0 | 0 | 0 | 27.4 | 28.9 | 29.6 |

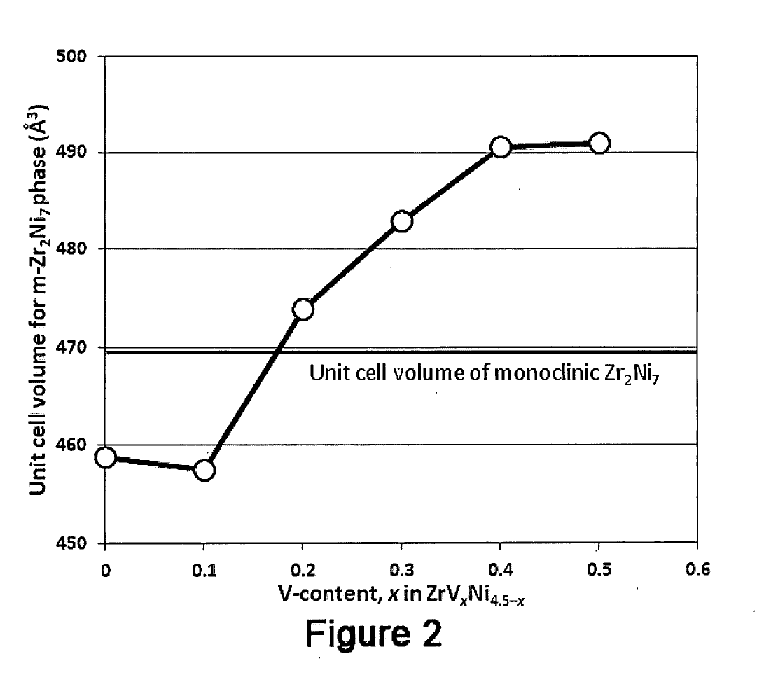

The unit cell volume of each phase increases as the V-content in the alloy increases except for the m-Zr₂Ni₇ phase in the alloy with very low V-content (YC#2). Considering that Zr is larger than V, and V is larger than Ni, the increase in unit cell volume indicates that V occupies the B-site and replaces Ni. The unit cell volume of m-Zr₂Ni₇ is plotted against the average V-content in the alloy in FIG. 2. In the m-Zr₂Ni₇ phase of YC#2, the decrease in unit cell volume is caused by V occupying the A-site at lower levels of V-substitution, which is similar to the case of lattice contraction observed in AB₂ MH alloy with small amount of Sn (≦0.1 at. %) substituting for Ni. A horizontal line was added in the graph of FIG. 2 to indicate the unit cell volume of a pure monoclinic Zr₂Ni₇ sample after annealing. While the unit cell volumes of the m-Zr₂Ni₇ phase for the first two alloys are smaller than that of the pure Zr₂Ni₇, those in the rest of alloys are larger. The lattice constants of ZrNi₅, ZrNi₉, and VNi₂ also increased with the increase in V-content. Therefore, preliminary observations from the lattice constant evolution in XRD analysis suggest that V mainly occupies the Ni-site in various phases.

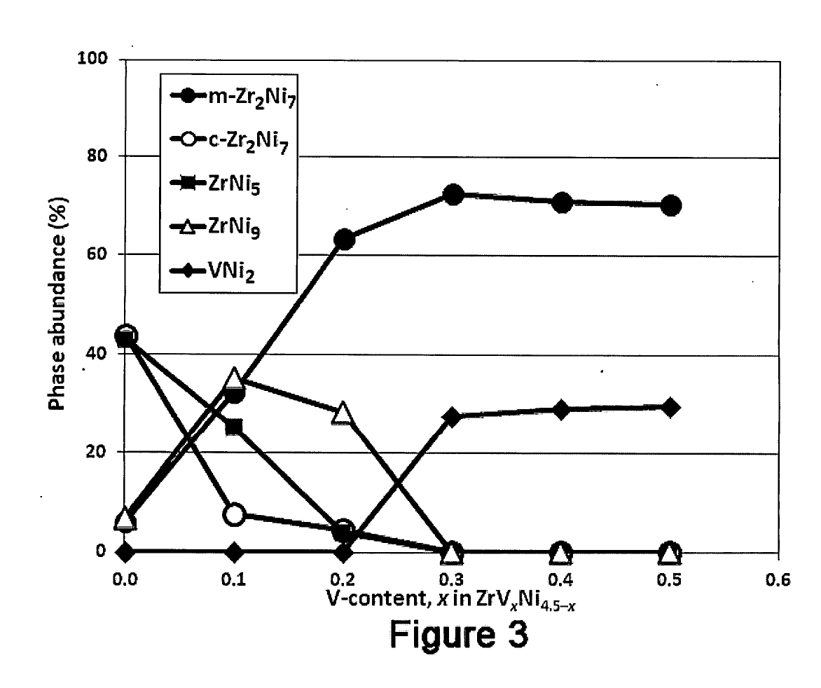

The phase abundances analyzed by Jade 9 software are listed in Table 2. FIG. 3 plots the phase abundances as functions of V-content in the alloy. The V-free YC#1 is composed of mainly c-Zr₂Ni₇ (symbol ◯) and ZrNi₅ (symbol ▪) with m-Zr₂Ni₇ (symbol ) and ZrNi₉ (symbol [symbol] ) as the secondary phases. With the increase in average V-content in the alloy, the main phase first shifts to m-Zr₂Ni₇/ZrNi₅/ZrNi₉ and then to m-Zr₂Ni₇ only. The secondary phase first changes into c-Zr₂Ni₇ and then to VNi₂ (symbol ♦). The phase abundances of alloys YC#4, 5, and 6 are very similar at about 70% m-Zr₂Ni₇ and 30% VNi₂.

### SEM/EDS Analysis

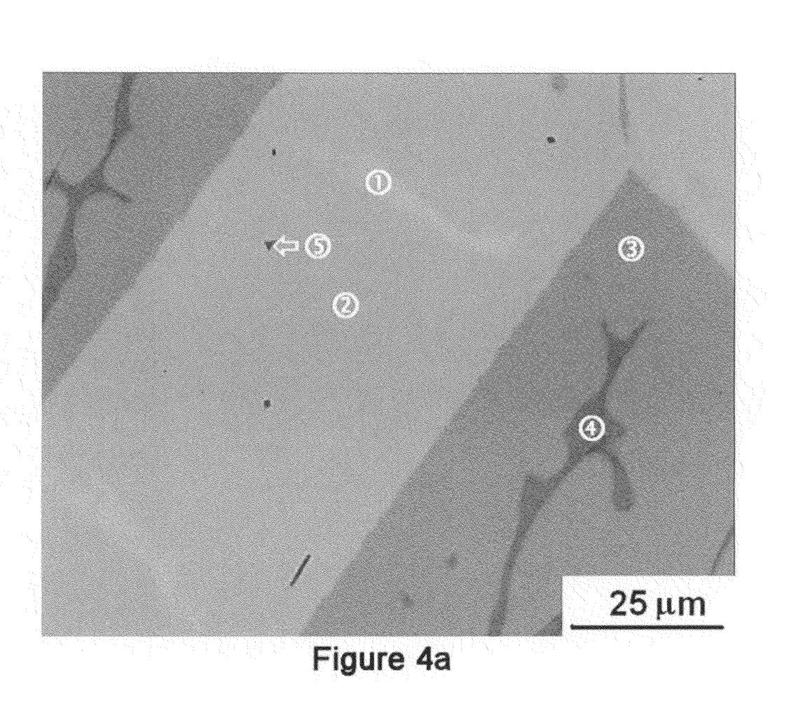

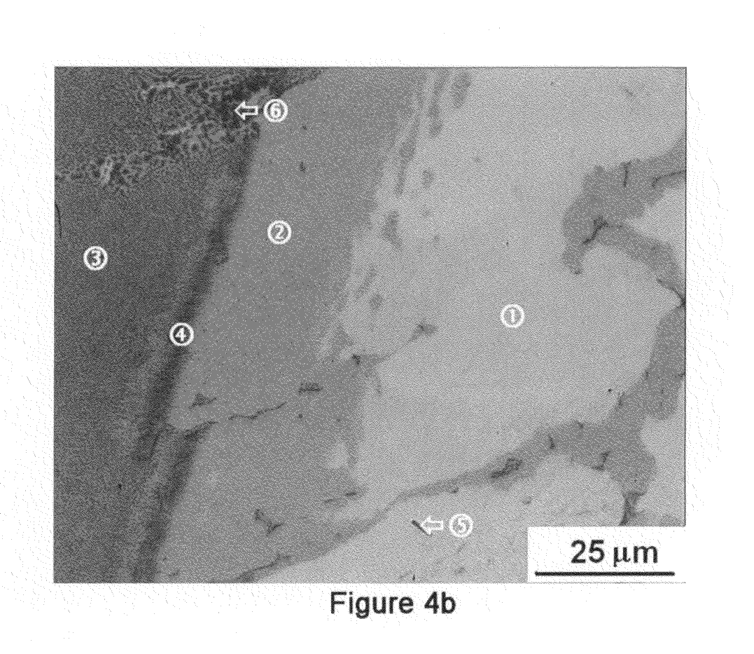

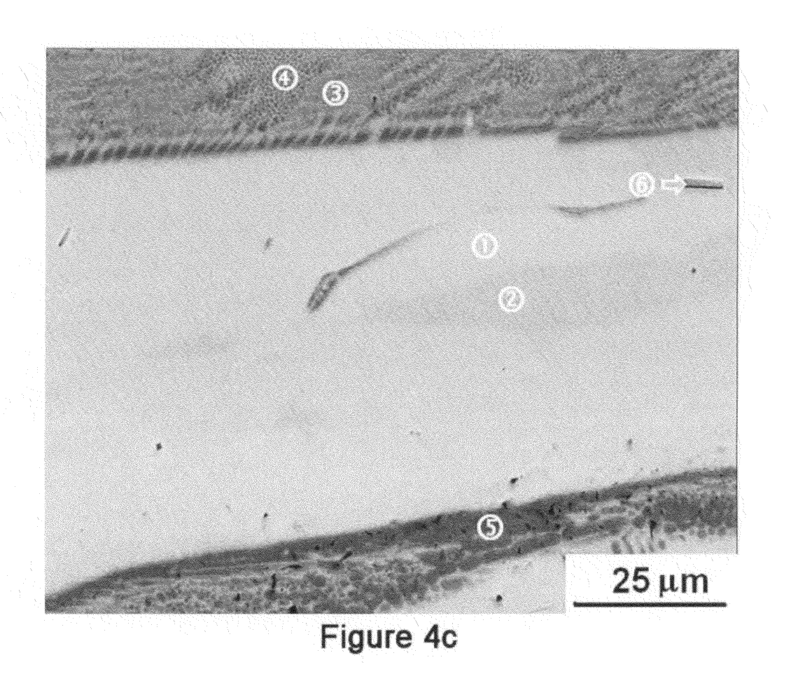

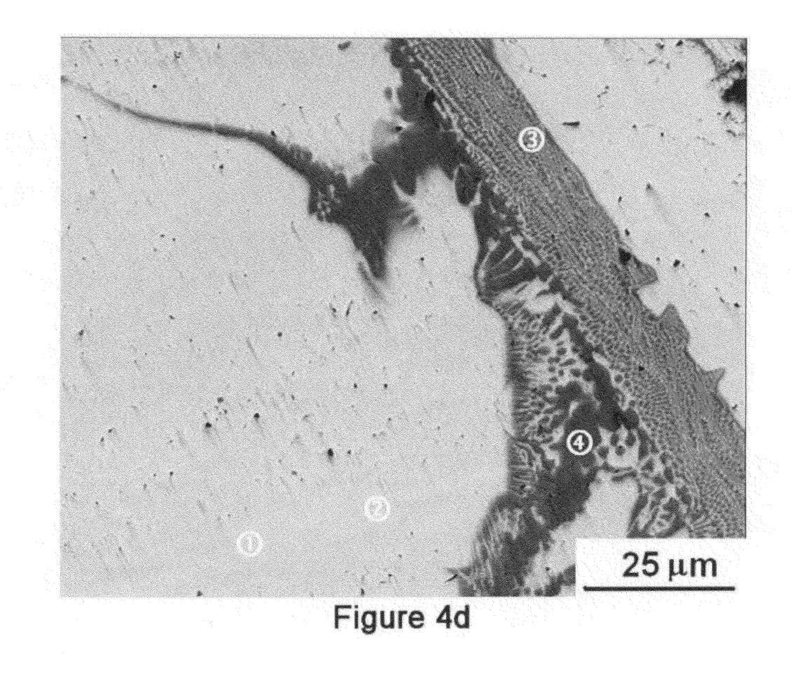

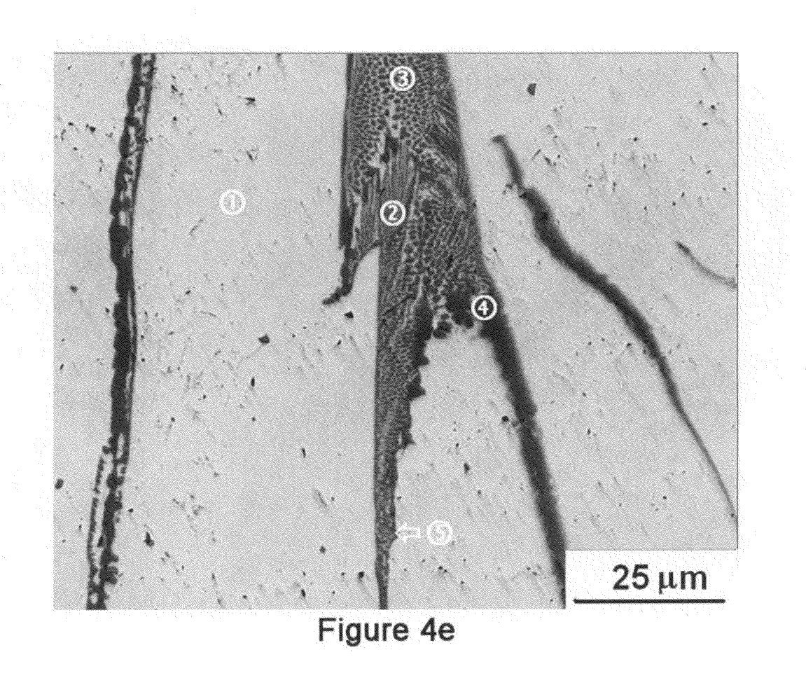

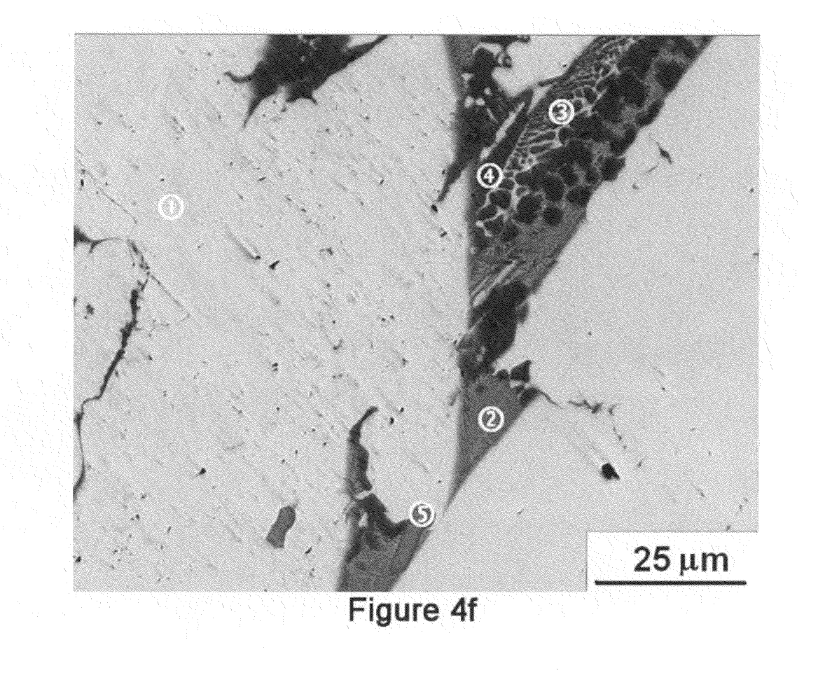

The microstructures for this series of alloys were studied using SEM, and the back-scattering electron images (BEI) of the six alloys (YC#1-YC#6) are presented in FIGS. 4a-4f, respectively. Samples were mounted and polished on epoxy blocks, rinsed and dried before being placed into the SEM chamber. The compositions in several areas (identified numerically in the micrographs) were analyzed using EDS, and the results are listed in Table 3.

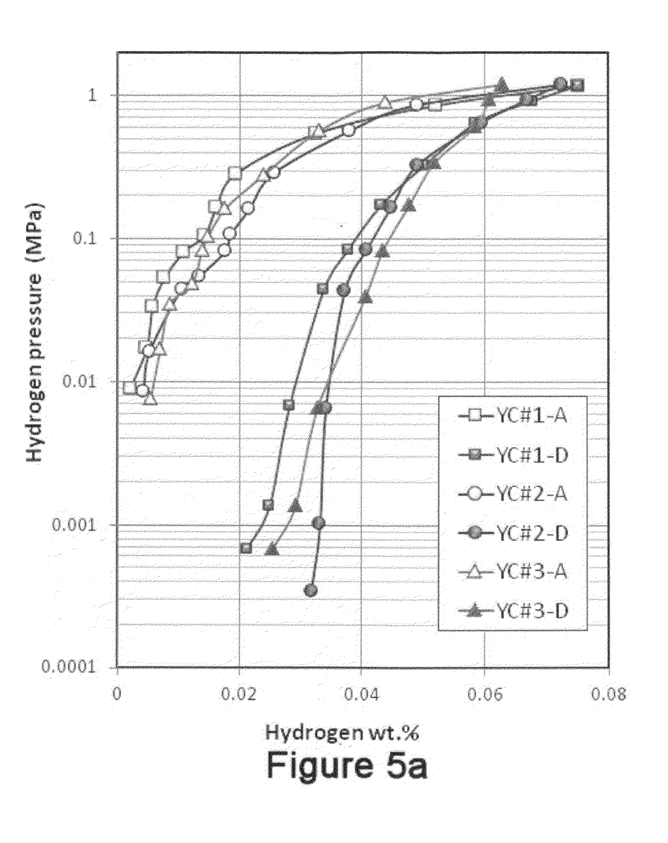

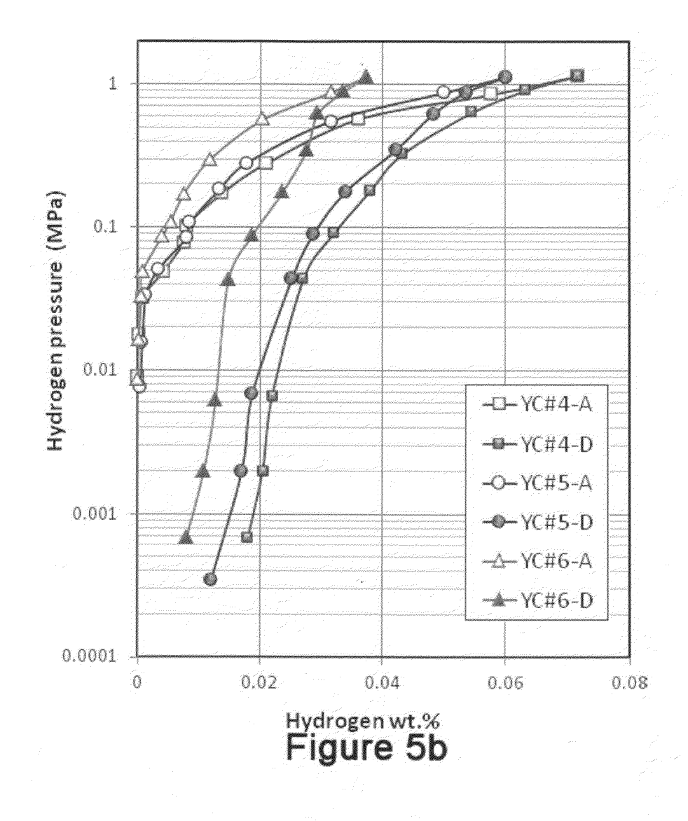

TABLE 3

| Alloy # | FIG. #/Ref# | Zr | Ni | V | (Ni + V)/Zr | Ni/(V + Zr) | Phase |
|---|---|---|---|---|---|---|---|
| YC#1 | FIG. 4a-1 | 22.4 | 77.6 | | 3.46 | 3.46 | m-Zr2Ni7 |
| | FIG. 4a-2 | 22.8 | 77.2 | | 3.39 | 3.39 | c-Zr2Ni7 |
| | FIG. 4a-3 | 17.3 | 82.7 | | 4.78 | 4.78 | ZrNi5 |
| | FIG. 4a-4 | 10.4 | 89.6 | | 8.62 | 8.62 | ZrNi9 |
| | FIG. 4a-5 | 48.9 | 51.1 | | 1.04 | 1.04 | ZrNi |
| YC#2 | FIG. 4b-1 | 22.3 | 77.4 | 0.3 | 3.48 | 3.42 | m-Zr2Ni7 |
| | FIG. 4b-2 | 17.1 | 82.4 | 0.5 | 4.85 | 4.68 | ZrNi5 |
| | FIG. 4b-3 | 10 | 83.1 | 6.9 | 9 | 4.92 | ZrNi9-I |
| | FIG. 4b-4 | 4.5 | 85.2 | 10.3 | 21.2 | 5.76 | ZrNi9-II |
| | FIG. 4b-5 | 36.5 | 63.2 | 0.3 | 1.74 | 1.72 | Zr3Ni5 |
| | FIG. 4b-6 | 1.5 | 83.8 | 14.8 | 65.7 | 5.14 | VNi3 |
| YC#3 | FIG. 4c-1 | 22.4 | 77 | 0.6 | 3.46 | 3.35 | m-Zr2Ni7 |
| | FIG. 4c-2 | 22.2 | 77.3 | 0.5 | 3.5 | 3.41 | c-Zr2Ni7 |
| | FIG. 4c-3 | 10.7 | 79.5 | 9.8 | 8.35 | 3.88 | ZrNi9-I |
| | FIG. 4c-4 | 12.1 | 78.7 | 9.2 | 7.26 | 3.69 | ZrNi9-I |
| | FIG. 4c-5 | 0.7 | 82.2 | 17.1 | 141 | 4.62 | VNi3 |
| | FIG. 4c-6 | 41.6 | 57.6 | 0.8 | 1.4 | 1.36 | Zr7Ni10 |
| YC#4 | FIG. 4d-1 | 22.1 | 77.2 | 0.7 | 3.52 | 3.39 | m-Zr2Ni7 |
| | FIG. 4d-2 | 22.1 | 76.9 | 0.8 | 3.52 | 3.36 | c-Zr2Ni7 |
| | FIG. 4d-3 | 7.1 | 75.4 | 17.4 | 13.1 | 3.08 | VNi2/Zr2Ni7 mix |
| | FIG. 4d-4 | 0.5 | 70.3 | 29.2 | 199 | 2.37 | VNi2 |
| YC#5 | FIG. 4e-1 | 22.4 | 76.4 | 1.1 | 3.46 | 3.25 | Zr2Ni7 |
| | FIG. 4e-2 | 6.7 | 70.5 | 22.8 | 13.9 | 2.39 | VNi2/Zr2Ni7 mix |
| | FIG. 4e-3 | 11.2 | 70.4 | 18.4 | 7.93 | 2.38 | VNi2/Zr2Ni7 mix |
| | FIG. 4e-4 | 0.6 | 68.2 | 31.2 | 165 | 2.14 | VNi2 |
| | FIG. 4e-5 | 77.6 | 16.6 | 5.9 | 0.29 | 0.2 | ZrO2 |
| YC#6 | FIG. 4f-1 | 22.6 | 75.7 | 1.6 | 3.42 | 3.13 | Zr2Ni7 |
| | FIG. 4f-2 | 7.2 | 55.4 | 37.4 | 12.9 | 1.24 | VNi2/Zr2Ni7 mix |
| | FIG. 4f-3 | 12 | 68.8 | 19.1 | 7.33 | 2.21 | VNi2/Zr2Ni7 mix |
| | FIG. 4f-4 | 0.7 | 62.1 | 37.2 | 141 | 1.64 | VNi2 |
| | FIG. 4f-5 | 94.4 | 4.8 | 0.8 | 0.06 | 0.05 | ZrO2 |

Both (Ni+V)/Zr and Ni/(V+Zr) values were calculated based on the compositions and are listed in the same table. In the V-free YC#1 alloy, the main phases are identified to be Zr₂Ni₇ (FIG. 4a-2) and ZrNi₅ (FIG. 4a-3). There are some traces of a phase with slightly brighter contrast that is embedded into the Zr₂Ni₇ phase and has a composition very close to Zr₂Ni₇ (FIG. 4a-1). According to the XRD analysis and the comparison of the microstructures of several alloys, these traces are believed to be the m-Zr₂Ni₇ phase with the main Zr₂Ni₇ phase being c-Zr₂Ni₇. While the ZrNi₉ secondary phase can be found within the ZrNi₅ main phase in the shape of a liquid droplet (FIG. 4a-4), the ZrNi secondary phase within the c-Zr₂Ni₇ phase is manifested as fine crystals with well-defined edges (FIG. 4a-5). In the next alloy, YC#2, three main phases can be found: Zr₂Ni₇ (FIG. 4b-1), ZrNi₅ (FIG. 4b-2), and ZrNi₉ (FIG. 4b-3). Within the Zr₂Ni₇ phase, some areas with slightly darker contrast can be identified. Based on the XRD results and the microstructure analysis, the majority of the Zr₂Ni₇ phase with slightly brighter contrast can be designated as the m-Zr₂Ni₇ phase, with the darker regions being the c-Zr₂Ni₇ phase. The major secondary phase with darker contrast (FIG. 4b-4) compared to the main phases is located between the ZrNi₅ and ZrNi₉ phases. This phase has a similar Ni-content to the main ZrNi₉ phase; however, its V-content is higher than the Zr-content. There must be some V occupying the Zr-site in this case; therefore, this phase is designated as the ZrNi₉-II phase. A sharp needle-like inclusion was found in the Zr₂Ni₇ matrix (FIG. 4b-5). With a Zr-to-Ni ratio of 3:5, this inclusion has a very small amount of V and can therefore be assigned as the Zr₃Ni₅ phase, which does not exist in the Zr—Ni binary phase diagram. Another secondary phase, the one with the darkest contrast, has a very small amount of Zr (FIG. 4b-6) and is assigned to be the VNi₃ phase according to the stoichiometry, which has a XRD diffraction pattern very close to that of TiNi₉. In YC#3, the brightest contrast comes from the main phase, m-Zr₂Ni₇ (FIG. 4c-1). The slightly darker region (FIG. 4c-2) and the sharp crystal (FIG. 4c-6) embedded in the matrix are from the c-Zr₂Ni₇ and Zr₇Ni₁₀ phases respectively. The secondary phases are mainly ZrNi₉ (FIGS. 4c-3 and 4c-4) and VNi₃ (FIG. 4c-5). The microstructures of the last three alloys are very similar: Zr₂Ni₇ as the matrix and VNi₂ as the secondary phase with occasional ZrO₂ inclusions. The V-content in the Zr₂Ni₇ phase increases slightly from 0.7 to 1.1 and then to 1.6 at. % while the V-content in the VNi₂ phase increases from 29.2 to 31.2 and then to 37.2 at. % in alloys YC#4, 5, and 6, respectively. The changes in Zr-content in these two phases are very small in the last three alloys.

### Gaseous Hydrogen Absorption Study

The gaseous phase hydrogen storage properties of the alloys were studied by PCT. The resulting absorption and desorption isotherms measured at 30° C. are shown in FIGS. 5a-5b, which plot the PCT isotherms for alloys YC#1-YC#3 (5a) and YC#4-YC#6 (5b). Open and solid symbols are for absorption and desorption curves, respectively. The shape of the isotherms (flat at the end) suggests incomplete hydride formation. More hydrogen can be stored at higher hydrogen pressure. The dual plateau feature can be found in all absorption and some desorption isotherms and indicates that more than one phase is capable of hydrogen storage. The maximum hydrogen storage capacities at 1.1 MPa in wt. % and H/M together with their equivalent electrochemical capacities (1 wt. %=268 mAh g⁻¹) are listed in Table 4.

TABLE 4

| | Max. H- | Max. H- | Max. H- | Rev. H- |
|---|---|---|---|---|
| | storage | storage | storage | storage |
| Alloy | (wt. %) | (H/M) | (mAh g−1) | (wt. %) |
| YC#1 | 0.075 | 0.048 | 20 | 0.054 |
| YC#2 | 0.072 | 0.046 | 19 | 0.041 |
| YC#3 | 0.063 | 0.04 | 17 | 0.037 |
| YC#4 | 0.071 | 0.046 | 19 | 0.053 |
| YC#5 | 0.06 | 0.038 | 16 | 0.048 |
| YC#6 | 0.037 | 0.023 | 10 | 0.029 |

In general, both the maximum and reversible hydrogen storage capacities decrease with the increase in V-content except for YC#4, where slight increases in both capacities are observed. According to the calculated average heats of hydride formation of various phases based on those from the constituent elements (ZrH₂: −106, VH₂: −40.2, and NiH₂: 20 kJ mol⁻¹ H₂ [32]), only the hydrides of Zr₂Ni₇ and ZrNi₅ are stable, and the strength of the metal-hydrogen bond increases in the order of Zr₂Ni₇>ZrNi₅>VNi₂>VNi₃>ZrNi₉. The trend of the maximum hydrogen storage capacity at 1.1 MPa does not match that of the Zr₂Ni₇ phase abundance due to the incompleteness of hydrogen absorption. The maximum capacities measured in this study are only about 20% of the capacity measured from a pure Zr₂Ni₇ alloy at 25° C. and 2.5 MPa (0.29 H/M). With the increase in V-content, both the PCT hysteresis and the irreversible storage capacity decreased.

### Electrochemical Measurement

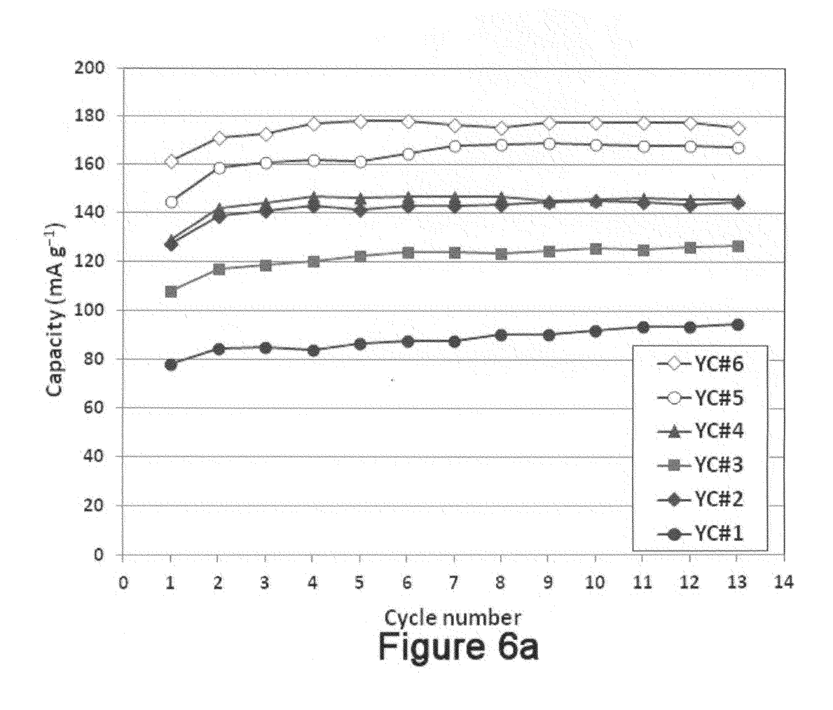

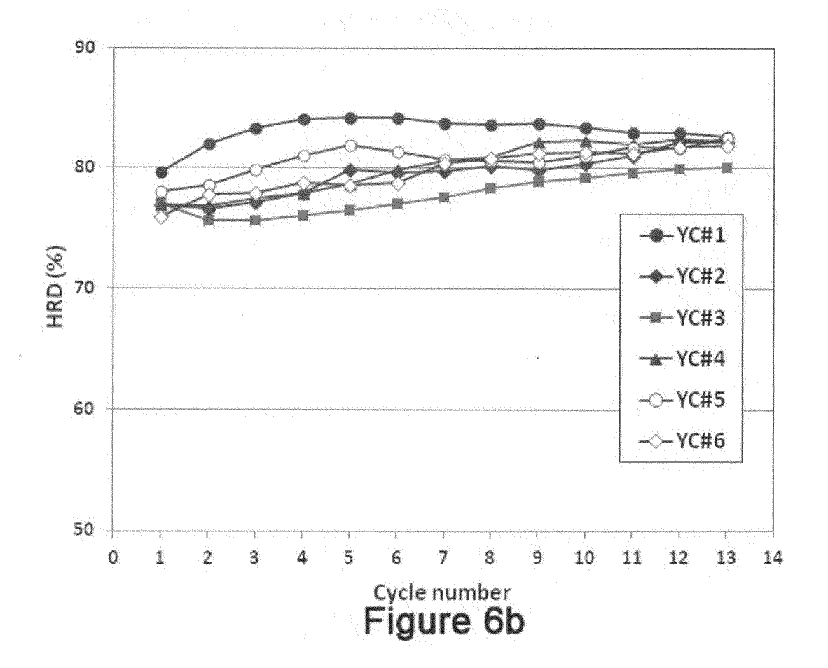

The discharge capacity of each alloy was measured in a flooded-cell configuration against a partially pre-charged Ni(OH)₂ positive electrode. No alkaline pretreatment was applied before the half-cell measurement. Each sample electrode was charged at a constant current density of 50 mA g⁻¹ for 10 h and then discharged at a current density of 50 mA g⁻¹ followed by two pulls at 12 and 4 mA g⁻¹. The obtained full capacities from the first 13 cycles are plotted in FIG. 6a FIG. 6a plots the half-cell discharge capacities of the six alloys (discharging at 4 mA g⁻¹) versus cycle number during the first 13 cycles. FIG. 6b plots the high-rate dischargeabilities of the six alloys versus cycle number during the first 13 cycles. All capacities stabilized after 3 cycles. High-rate (discharging at 50 mA g⁻¹) and full capacities measured at the 10^{th} cycle are listed in Table 5.

TABLE 5

| Alloy | YC#1 | YC#2 | YC#3 | YC#4 | YC#5 | YC#6 |
|---|---|---|---|---|---|---|
| Full capacity @ 10th cycle (mAh g−1) | 92 | 145 | 125 | 146 | 168 | 177 |
| Full capacity @ 10th cycle (H/M) | 0.22 | 0.35 | 0.3 | 0.35 | 0.4 | 0.42 |
| High-rate capacity @ 10^{th} cycle (mAh g−1) | 77 | 116 | 99 | 120 | 136 | 144 |
| Activation cycle reaching 95% of HRD @10^{th} cycle | 1 | 1 | 1 | 5 | 1 | 2 |
| HRD @ 10th cycle | 0.84 | 0.8 | 0.79 | 0.82 | 0.81 | 0.81 |
| OCV (V) | 1.28 | 1.27 | 1.28 | 1.3 | 1.31 | 1.32 |
| Equiv. PCT plateau pressure using Nernst Eq. (MPa) | 0.03 | 0.02 | 0.04 | 0.14 | 0.29 | 1.13 |
| Equiv. PCT mid-point desorption pressure (MPa) | 0.04 | 0.03 | 0.04 | 0.08 | 0.11 | 0.22 |
| Diffusion coefficient D (10⁻¹⁰ cm² s⁻¹) | 6.06 | 5.21 | 5.12 | 5.44 | 4.91 | 4.58 |
| Exchange current Iₒ (mA g⁻¹) | 20.1 | 29.9 | 30.7 | 32 | 29.3 | 24.6 |

Except for YC#3, both discharge capacities increase with the increase in V-content. The equivalent hydrogen storage capacities in H/M, based on the full discharge capacities (listed in Table 5) are 5 to 15 times higher than those measured in the gaseous phase (Table 4). The maximum storage capacity (reversible +irreversible) measured by PCT has always been considered to be the upper bound for the electrochemical discharge capacity. The observation of the electrochemical discharge capacity being higher than the maximum gaseous phase storage capacity in the current study is unexpected. The storage capacities measured in the electrochemical environment are also higher than that measured from a pure Zr₂Ni₇ alloy at 25° C. and 2.5 MPa (H/M=0.29). Therefore, the Zr₂Ni₇ phase alone cannot account for the relatively high electrochemical discharge capacity of these alloys. A fraction of the capacity of Zr₂Ni₇ was not accessible in the gaseous phase due to the limited pressure range. However, in the electrochemical environment, extra capacity was measured. It is logical to assume the extra capacity was from the higher equivalent hydrogen pressure from the applied voltage (29 mV difference=1 decade of H₂ pressure difference). The open-circuit voltage (OCV) at 50% state-of-charge during discharge of each sample is also listed in Table 5. Two methods were employed to estimate the equivalent gaseous phase equilibrium hydrogen pressure. In the first method, the Nernst equation (1) was applied with an equilibrium potential of Ni(OH)₂ at 0.36 V vs. Hg/HgO reference electrode. The equation is derived from the well-defined a-to-b transition, such as in the case of LaNi₅.

E_{eq} (MH vs. HgO/Hg)=−0.9324−0.0291 log P_{H2} volt (1)

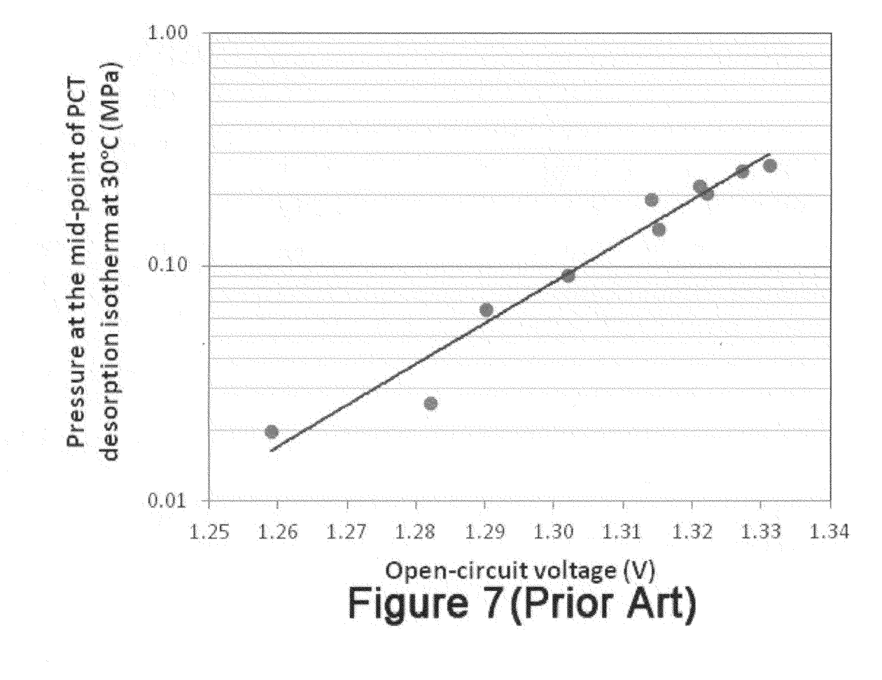

The equivalent gaseous phase plateau pressures are listed in Table 5 and range between 0.032 and 1.126 MPa. The plateau pressures of the first five alloys in the electrochemical system are lower than the highest pressure employed in the PCT apparatus (1.1 MPa). Therefore, the electrochemical environment is able to reduce the hydrogen storage plateau pressure and consequently increases the storage capacity. The second method of estimating the equivalent gaseous phase equilibrium hydrogen pressure was considered due to the fact that most of the disordered MH alloys lack well-defined plateaus in the a-to-b transition in the PCT isotherm. Instead of the Nernst equation, an empirical relationship between the mid-point pressure in the PCT desorption isotherm and OCV (FIG. 7) was established based on the data obtained from two series of off-stoichiometric AB₂ and AB₅ alloys. FIG. 7 plots the open circuit voltage vs. pressure at the mid-point of PCT desorption isotherm measured at 30° C. from two series of prior art off-stoichiometric MH alloys (AB2 and AB5). The good linear fitting (R²=0.96) of the curve can be expressed as:

log(mid-point pressure)=17.55OCV−23.87 (2)

Using eq. (2), the equivalent gaseous phase mid-point desorption pressure was calculated from the OCV of each sample and is listed in Table 5. The resulting pressures are also much lower than the highest pressure employed in the PCT apparatus. Therefore, the calculations from both methods show consistent results: in the electrochemical environment, higher storage capacity was obtained due to the reduction in equilibrium hydrogen pressure.

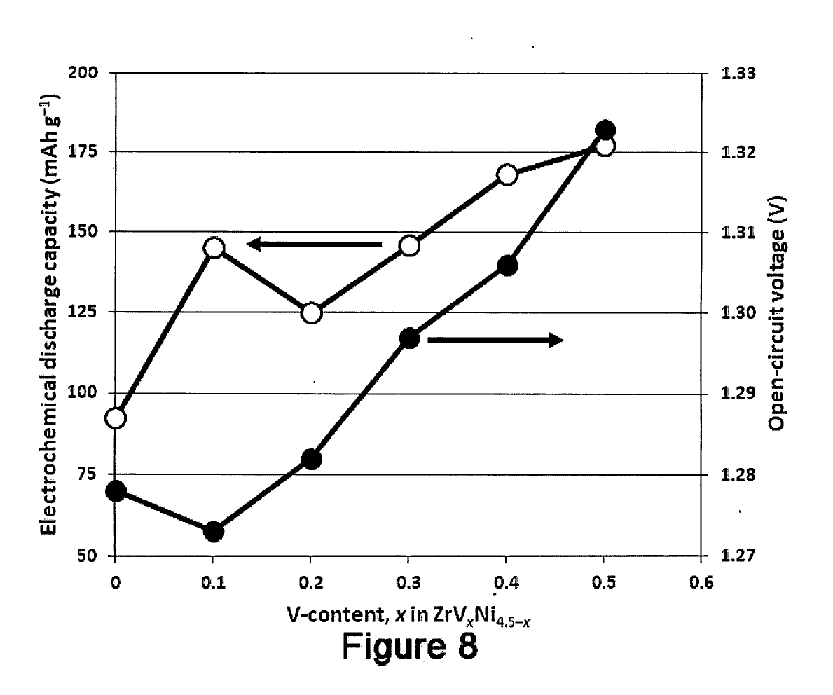

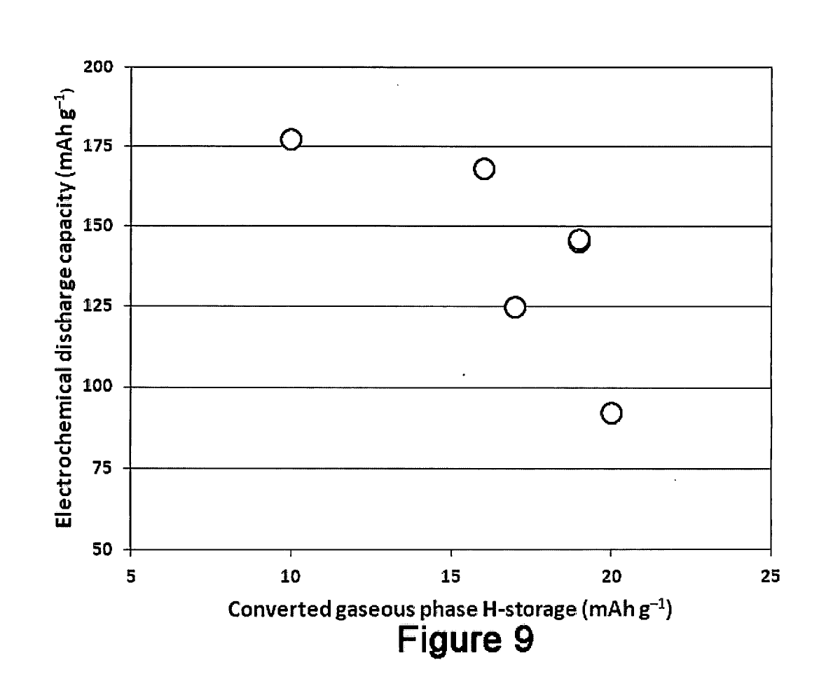

FIG. 8 plots the full discharge capacities at the 10th cycle (open symbol) and open circuit voltage (solid symbol) as functions of V-content in the alloy for the six alloys YC#1-YC#6. OCV increases as the V-content increases except for alloy YC#2. The drop in OCV and the boost in discharge capacity in YC#2 may be related to the shrinkage in unit cell volume of the m-Zr₂Ni₇ phase as shown in FIG. 2. With the increase in the amount of V substituting Ni, the average strength of metal-hydrogen bond increases, and higher discharge capacity is expected and observed. However, OCV, which is closely related to the equilibrium hydrogen pressure, is expected to decrease with the increase in metal-hydrogen bond strength, which is not seen in the current study. As stated in the previous paragraph, the OCV was altered by the electrochemical environment and is lower than the value expected from the gaseous phase PCT analysis. The increase in OCV with the increase in V-content indicates that the charge/discharge characteristics in this multi-phase alloy system are strongly influenced by either the surface modification due to the reaction with KOH or by the synergetic effect from the catalytic secondary phases as seen in multi-phase AB₂ MH alloy systems. The discrepancy between the gaseous phase and electrochemical behaviors is further highlighted when the discharge capacity is plotted against the maximum gaseous phase hydrogen storage capacity. FIG. 9 plots the measured electrochemical discharge capacity vs. calculated electrochemical discharge capacity converted from the gaseous phase hydrogen storage measurements using the conversion 1 wt. % of hydrogen storage=268 mAh g−1. Instead of a positive correlation expected between capacities from the gaseous phase and wet chemistry, a negative correlation is observed. Alloys with higher maximum gaseous phase storage capacities show lower electrochemical discharge capacities.

The half-cell HRD of each alloy, which is defined as the ratio of the discharge capacity measured at 50 mA g⁻¹ to that measured at 4 mA g⁻¹, for the first thirteen cycles are plotted in FIG. 6b. Most of the alloys, except for YC#4 and YC#6, achieve 95% of the stabilized HRD in the first cycle, which shows very easy activation. HRDs at the 10^{th} cycle are listed in Table 5. HRDs in all V-containing alloys are similar and slightly lower than that of the V-free alloy. These HRDs are relatively low compared to those measured in the commercial AB₂ and AB₅ alloys. In order to further improve HRDs of the alloy system in this study, more modifying elements, such as Mn, Al, Co, and Sn, are needed.

With the intention of further understanding the source of the degradation in HRD of the V-containing alloys, both the bulk diffusion coefficient (D) and the surface exchange current (Iₒ) were measured. The details of both parameters' measurement techniques are known in the art, and the values are listed in Table 5. The D values from the V-containing alloys are lower than that measured in the V-free alloy. However, they are much higher than those measured in other MH alloy systems, such as AB₂ (9.7×10⁻¹¹ cm² s⁻¹), AB₅ (2.55×10⁻¹⁰ cm^{2 s}⁻¹), La-A₂B₇ (3.08×10⁻¹⁰ cm² s⁻¹), and Nd-A₂B₇ (1.14×10⁻¹⁰ cm² s⁻¹). The bulk proton transport property of the Zr-based AB₅ alloy in the current study is the best among all alloy systems tested so far. In contrast with the D values, Iₒ's in the V-containing alloys are higher than that in the V-free YC#1 alloy, and the values are close to that in the AB₂ alloy (32.1 mA g⁻¹) but lower than those in AB₅ (43.2 mA g⁻¹) and La-A₂B₇ (41.0 mA g⁻¹). With high Ni-content in the alloy formula, high surface catalytic capability in the Zr(V,Ni)_{4.5} alloy system is expected but not seen in the current study. Other commonly used modifying elements in AB₂ and AB₅ MH alloys, such as Mn and Co, should improve the surface property of the alloy system in this study. Judging from the D and Iₒ values in the alloys, it is concluded that HRD (high rate of 50 mA g⁻¹) of the alloy system in this study is mainly determined by the bulk proton transport.

### Further Testing

In order to further investigate the discrepancy between the gaseous phase storage and electrochemical discharge capacities, their correlations to the phase abundances are listed in Table 6.

TABLE 6

| | Max. Gaseous Cap. | Electrochem. Cap. | OCV |
|---|---|---|---|
| m-Zr₂Ni₇ % | 0.33 | 0.6 | 0.49 |
| c-Zr₂Ni₇ % | 0.24 | 0.73 | 0.28 |
| Zr₂Ni₇-total | 0.28 | 0.23 | 0.56 |
| ZrNi₅ | 0.35 | 0.61 | 0.48 |
| ZrNi₉ + VNi₃ | 0.23 | 0.09 | 0.56 |
| VNi₂ | 0.34 | 0.61 | 0.82 |
| ZrNi₉ + VNi₃ + VNi₂ | 0.12 | 0.59 | 0.06 |
| V-content | 0.7 | 0.8 | 0.9 |

The only significant correlation of the gaseous phase is to the average V-content. The increase in V-content reduces the maximum gaseous phase storage capacity. Judging from the shapes of the PCT isotherms, the reduction in capacity is mainly due to the increase in plateau pressure but not to the reduction in plateau range. The other observation is that with the increase in V-content, less hydrogen is stored irreversibly, which indicates that the metal-hydrogen bond strength becomes weaker; this result agrees with the increasing trend of the plateau pressure. V substituting for Ni in most of the MH alloy systems increases the metal-hydrogen bond strength due to the higher proton affinity of V. In this case, the trend of the plateau pressure is just the opposite: the metal-hydrogen bond strength is weaker at higher V-content. Therefore, it seems that the gaseous phase properties of this alloy system are not governed by any individual phase nor are they governed by the average proton affinity of the alloy.

The electrochemical capacity (see Table 6), correlates very well to the abundances of several phases, such as both m- and c-Zr₂Ni₇ phases, the ZrNi₅ phase, and the VNi₂ phase. The correlation between the electrochemical capacity and the average V-content is the most significant. With the increase in V-content, the average proton affinity of the alloy increases and contributes to a higher electrochemical storage capacity, which is in opposition with the finding from the gaseous phase study. OCV correlates well with the abundances of several phases, especially with VNi₂ (R²=0.82). Its correlation to the V-content is the most significant (R²=0.90) among all. A higher V-content should increase the proton affinity and consequently reduce the plateau pressure and OCV. On the contrary, the results in this study show that a higher V-content corresponds to a higher OCV, which is consistent with the observed trend in PCT plateau pressure but not with the trend in electrochemical capacity. Therefore, the conclusion is that while the average V-content is the most significant correlation factor with these three properties, the change in gaseous phase characteristic is similar to the image in OCV, and the mechanism that causes the disagreement with the expected requires further study. The evolution of the electrochemical capacity follows well from predictions made by looking at the average proton affinity of the alloy.

### EXAMPLE 2

### ZrVₓNi_{3.5-x}

The structure, gaseous storage, and electrochemical properties of a series of ZrVₓNi_{3.5-x}(x=0.0 to 0.9) metal hydride alloys were studied. As V-content in the alloy was increased, the main Zr₂Ni₇ phase shifted from a monoclinic to a cubic structure, both ZrNi₃ and ZrNi₅ phase abundances decreased, equilibrium pressure increased, both gaseous phase and electrochemical storage increase and then decrease, and both the high-rate dischargeability and bulk diffusion constant increase. The measured electrochemical discharge capacity was higher than that measured in gaseous phase, and was explained by the synergetic effect from the secondary phase.

Ten alloys with V substituting for Ni at various levels (ZrVₓNi_{3.5-x}=0.0, 0.1, 0.2, 0.3, 0.4, 0.5, 0.6, 0.7, 0.8, and 0.9) were prepared by arc melting. A B/A ratio of 3.5 was kept constant. ICP results are consistent with the design within 3%. The ingots were not annealed in order to preserve the secondary phases, which may be beneficial to the electrochemical properties. The design compositions are summarized in Table 7.

TABLE 7

| | Zr | Ni | V | (V + Ni)/Zr | Formula | Formula wt |
|---|---|---|---|---|---|---|
| YC#7 | 22 | 78 | 0 | 35 | ZrNi3.5 | 296.3 |
| YC#8 | 22 | 75.8 | 2.2 | 3.5 | ZrV0.1Ni3.4 | 295.6 |
| YC#9 | 22 | 73.6 | 4.4 | 3.5 | ZrV0.2Ni3.3 | 294.8 |
| YC#10 | 22 | 71.4 | 6.6 | 3.5 | ZrV0.3Ni3.2 | 294 |
| YC#11 | 22 | 69.2 | 8.8 | 3.5 | ZrV0.4Ni3.1 | 293.3 |
| YC#12 | 22 | 67 | 11 | 3.5 | ZrV0.5Ni3.0 | 292.5 |
| YC#13 | 22 | 64.8 | 13.2 | 3.5 | ZrV0.6Ni2.9 | 291.7 |
| YC#14 | 22 | 62.6 | 15.4 | 3.5 | ZrV0.7Ni2.8 | 291 |
| YC#15 | 22 | 60.4 | 17.6 | 3.5 | ZrV0.8Ni2.7 | 290.2 |
| YC#16 | 22 | 58.2 | 19.8 | 3.5 | ZrV0.9Ni2.6 | 289.4 |

### XRD Structure Analysis

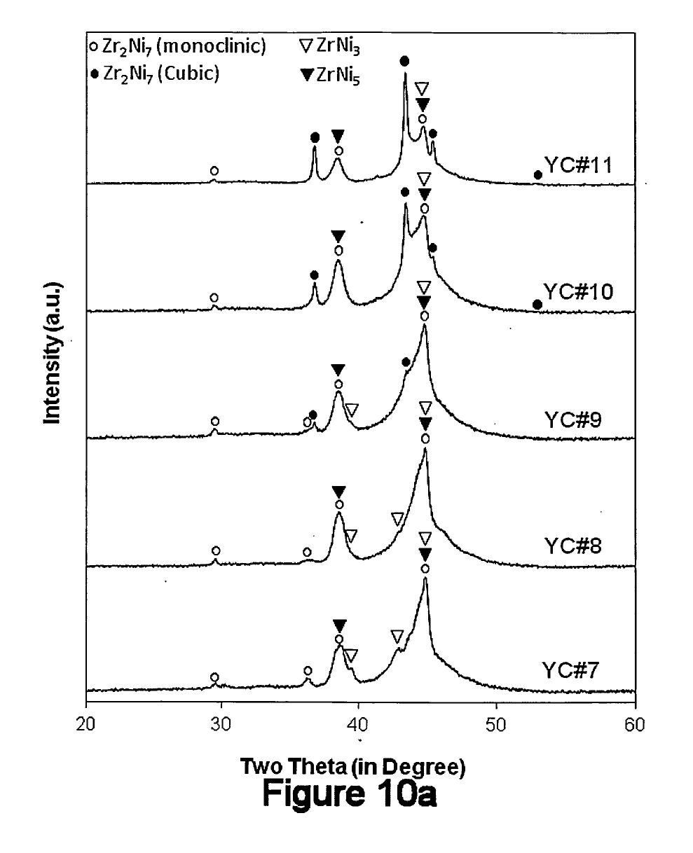

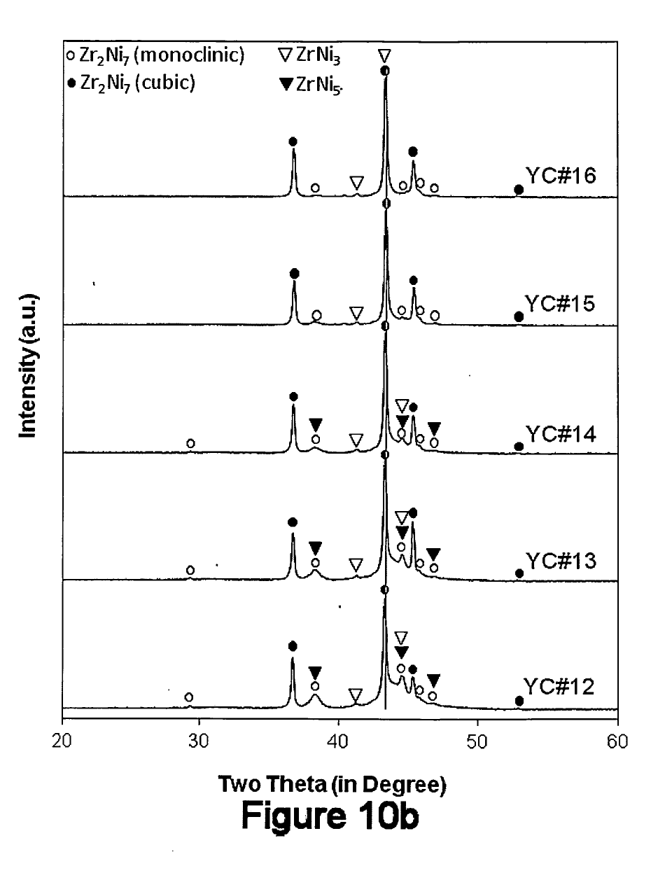

The XRD patterns of the ten alloys are shown in FIGS. 10a and 10b. Four structures can be identified: a monoclinic Zr₂Ni₇ (m-Zr₂Ni₇ symbol ∘), a cubic Zr₂Ni₇ (c-Zr₂Ni₇ symbol ), a hexagonal ZrNi₃ phase (symbol ∇) and a cubic ZrNi₅ phase (symbol ▾). The first structure, a stable structure of Zr₂Ni₇ after annealing, is monoclinic with lattice constants a=4.698 Å, b=8.235 Å, c=12.193 Å, b=95.83° and unit cell volume=469.3 Å³. The second structure, a metastable structure of Zr₂Ni₇, is cubic with lattice constant a=6.68 Å. The third is a hexagonal-structured ZrNi₃ with lattice constant a=5.309 Å and c=4.303 Å. The fourth structure, a ZrNi₅ cubic structure, is AuBe₅-type. Its reported lattice constant a varies slightly among different groups, ranging from 6.702 to 6.683 Å. Lattice constants and phase abundances obtained from XRD are listed in Table 8. As the V-content in the alloys increased, the main phase shifted from m-Zr₂Ni₇ to c-Zr₂Ni₇, the amount of secondary phases of ZrNi₃ and ZrNi₅ decreased, the unit cell volumes of c-Zr₂Ni₇ phase remained relatively constant, those in the m-Zr₂Ni₇ phase increased.

TABLE 8

| Alloy | YC#07 | YC#08 | YC#09 | YC#10 | YC#11 | YC#12 | YC#13 | YC#14 | YC#15 | YC#16 |
|---|---|---|---|---|---|---|---|---|---|---|
| x in ZrVₓNi_{3.5-x} | 0 | 0.1 | 0.2 | 0.3 | 0.4 | 0.5 | 0.6 | 0.7 | 0.8 | 0.9 |
| c-Zi₂Ni_{7,} a (Å) | — | — | 6.9256 | 6.9235 | 6.9245 | 6.9261 | 6.925 | 6.9284 | 6.9237 | 6.929 |
| m-Zi₂Ni_{7,} a (Å) | 4.6139 | 4.6355 | 4.6398 | 4.6582 | 4.6875 | 4.6946 | 4.6973 | 4.6989 | 4.714 | 4.9173 |
| m-Zi₂Ni_{7,} b (Å) | 8.2044 | 8.2034 | 8.2204 | 8.2711 | 8.2674 | 8.278 | 8.301 | 8.2989 | 8.2829 | 8.1193 |
| m-Zi₂Ni_{7,} c (Å) | 12.1188 | 12.1312 | 12.1347 | 12.3275 | 12.3857 | 12.377 | 12.3877 | 12.3998 | 12.4114 | 12.4122 |
| m-Zi₂Ni_{7,} b (°) | 93.91 | 94.21 | 94.3 | 94.5 | 94.27 | 94.23 | 94.32 | 94.3 | 94.08 | 93.58 |
| m-Zi₂Ni₇, Vol. | 457.7 | 460.1 | 461.5 | 473.5 | 478.7 | 479.7 | 481.7 | 482.2 | 483.4 | 494.6 |
| (Å³) | | | | | | | | | | |
| ZrNi_{3,} a (Å) | 5.2879 | 5.3142 | 5.3187 | 5.4099 | 5.4551 | 5.4688 | 5.4754 | 5.4766 | 5.4725 | 5.5145 |
| ZrNi_{3,} c (Å) | 4.3517 | 4.3606 | 4.3804 | 4.4369 | 4.3241 | 4.336 | 4.3515 | 4.3636 | 4.3867 | 4.3755 |
| ZrNi_{5,} a (Å) | 6.6418 | 6.65 | 6.6671 | 6.7438 | 6.8496 | 6.8613 | 6.7609 | 6.866 | — | — |
| c-Zr₂Ni₇ % | — | — | 6.4 | 26.4 | 52.9 | 67.6 | 76.4 | 84.3 | 89 | 93.8 |
| m-Zr₂Ni₇ % | 77.1 | 75.3 | 73.2 | 54.7 | 36.1 | 26.2 | 15.6 | 14.2 | 10.5 | 5.6 |
| ZrNi₃ % | 17.7 | 17.6 | 16.9 | 12.5 | 7.3 | 3.4 | 5.2 | 0.7 | 0.5 | 0.6 |
| ZrNi₅ % | 5.2 | 7.1 | 3.5 | 6.5 | 3.7 | 2.8 | 2.7 | 0.8 | — | — |

### SEM/EDS Analysis

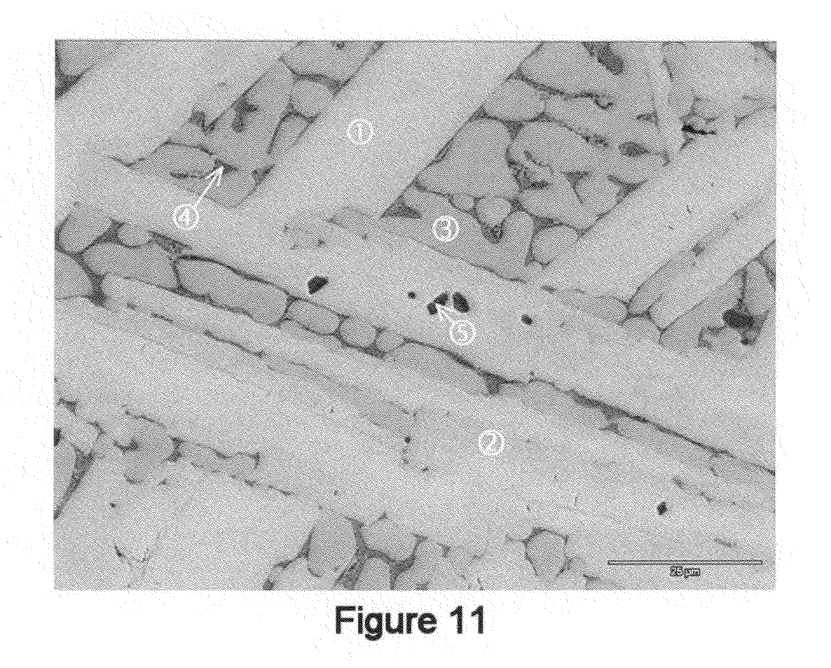

The microstructures for this series of alloys were studied using SEM, and a back-scattering electron image (BEI) of sample YC#12, which is shown in FIG. 11. This figure is exemplary of the micrographs of all of the samples. Clear phase segregation can be seen from the micrograph. Two phases of Zr₂Ni₇ can be identified (spots 1 and 2) with slightly different in contrast and V-content. Without an in-situ electron backscattering diffraction pattern, we cannot assign crystal structures (c- or m-) to these two phases. Secondary phases of ZrNi₃ and ZrNi₅ (making the average composition ZrNi_{3.5}) are interposed with each other and the sides of these parallelogram-shape secondary phase regions are parallel, which suggests certain crystallographic orientation alignment between the main Zr₂Ni₇ phase and the ZrNi₃/ZrNi₅ secondary phase. According to the Zr—Ni binary phase diagram, during solidification of a liquid with composition close to Zr₂Ni₇, the Zr₂Ni₇ phase solidifies first, and then further solid-state transformation creates both the ZrNi₃ and ZrNi₅ phases. Observing FIG. 11, it looks like ZrNi₃ (spot 3) was formed first pushing excess Ni to the grain boundary, forming the ZrNi₅ phase (spot 4). Upon annealing of the samples, these secondary phases are expected to vanish.

### Gaseous Phase Study

The gaseous phase hydrogen storage properties of the alloys were studied by PCT measured at 45° C. Unlike long-term annealed Zr₂Ni₇ alloys, the inventive sample alloys were not quick to absorb the hydrogen. Therefore, higher temperature (45° C.) was used to study the gaseous phase storage properties of these alloys. The difference in kinetics between as-cast and annealed alloys might come from the smaller grain size of the former impeding the diffusion of hydrogen in the bulk. For alloys with higher V-contents, the shape of the isotherms (flat at the end) suggests incomplete hydride formation. More hydrogen can be stored at higher hydrogen pressure. The maximum and revisable hydrogen storage capacities at 1.5 MPa in mAh g⁻¹ (1 wt. %=268 mAh g⁻¹) are listed in Table 9.

In general, the maximum capacity decreased in the beginning and increased and stabilized afterward and the reversible capacity increased with the increase in the V-content. The changes in maximum capacity might be related to the main Zr₂Ni, phase abundance while the increases in the reversible capacities are from the increasing plateau pressure with increase in the V-content.

TABLE 9

| Alloy | YC#07 | YC#08 | YC#09 | YC#10 | YC#11 | YC#12 | YC#13 | YC#14 | YC#15 | YC#16 |
|---|---|---|---|---|---|---|---|---|---|---|
| Gaseous phase max. capacity | 59 | 48 | 43 | 35 | 40 | 64 | 70 | 67 | 67 | 67 |
| (mAh g−1) | | | | | | | | | | |
| Gaseous phase reversible | 16 | 19 | 11 | 19 | 35 | 56 | 56 | 67 | 59 | 60 |
| capacity (mAh g−1) | | | | | | | | | | |
| Full capacity @ 10th cycle | 87 | 97 | 95 | 98 | 106 | 108 | 114 | 109 | 90 | 90 |
| (mAh g−1) | | | | | | | | | | |
| High-rate capacity @ 10^{th} | 71 | 79 | 79 | 81 | 87 | 92 | 97 | 96 | 81 | 85 |
| cycle (mAh g−1) | | | | | | | | | | |
| HRD @ 10th cycle | 81% | 81% | 82% | 82% | 81% | 85% | 85% | 89% | 91% | 95% |
| OCV (V) | 1.299 | 1.326 | 1.317 | 1.321 | 1.347 | 1.356 | 1.355 | 1.361 | 1.367 | 1.369 |
| Equiv. PCT plateau press. | 0.17 | 1.42 | 0.7 | 0.96 | 7.52 | 15.3 | 14.2 | 22.7 | 36.6 | 42.8 |
| from Nurnst Eq. (MPa) | | | | | | | | | | |
| Equivalent PCT mid-point | 0.08 | 0.25 | 0.18 | 0.21 | 0.59 | 0.85 | 0.81 | 1.04 | 1.32 | 1.43 |
| desorption pressure (MPa) | | | | | | | | | | |
| Diffusion coefficient D | 4.1 | 3.9 | 4 | 4.2 | 5.5 | 5.6 | 6.3 | 6.8 | 7 | 7.3 |
| (10⁻¹⁰ cm² s⁻¹) | | | | | | | | | | |
| Exchange current Iₒ (mA g⁻¹) | 22.3 | 20.9 | 22.4 | 20.2 | 17.7 | 14.8 | 15.2 | 16.8 | 16.2 | 17.3 |

### Electrochemical Capacity Measurement

The discharge capacity of each alloy was measured in a flooded-cell configuration against a partially pre-charged Ni(OH)₂ positive electrode. Each sample electrode was charged at a constant current density of 50 mA g⁻¹ for 10 h and then discharged at a current density of 50 mA g⁻¹ followed by two pulls at 12 and 4 mA g⁻¹. All capacities stabilized after 3 cycles. High-rate (obtained by discharging at 50 mA g⁻¹) and full capacities (obtained by adding capacities at three rates together) measured at the 10^{th} cycle are listed in Table 9. Both capacities increased and then decreased with the increasing V-content, with the maximum of both obtained with YC#13 (ZrV_{0.6}Ni_{2.9}). As is the case with example 1 above (i.e. ZrVₓNi_{4.5-x}), the electrochemical discharge capacity is higher than the capacity obtained from gaseous phase measurement through the synergetic effect of secondary phases. The full electrochemical capacity of any as-cast alloy in this study is higher than that measured in the gaseous phase from a pure Zr₂Ni₇ alloy at 25° C. and 2.5 MPa (H/M=0.29, 77 mAh g⁻¹). Therefore, the Zr₂Ni₇ phase alone cannot account for the relatively high electrochemical discharge capacity seen here. A fraction of the capacity of Zr₂Ni₇ was not accessible in the gaseous phase due to the limited pressure range. However, in the electrochemical environment, extra capacity was measured. It is logical to assume the extra capacity was from the higher equivalent hydrogen pressure from the applied voltage. The open-circuit voltage (OCV) at 50% state-of-charge during discharge of each sample is also listed in Table 9. Again, as with the ZrVₓNi_{4.5-x} alloys of example 1, two methods were employed to estimate the equivalent gaseous phase equilibrium hydrogen pressure. The equivalent gaseous phase plateau pressures calculated by Nernst equation (eq. 1 above) are listed in the 8^{th} row of Table 9. The plateau pressures of three alloys (YC#07, #09, and #10) in the electrochemical system are lower than the highest pressure employed in the PCT apparatus (1.1 MPa) where the plateau was not observed. Therefore, for at least these three alloys, the electrochemical environment is able to reduce the hydrogen storage plateau pressure and consequently increases the storage capacity. Using an empirical equation (eq. 2 above), the equivalent gaseous phase mid-point desorption pressure was calculated from the OCV of each sample and is listed in the 9^{th} row of Table 9. Almost all pressures calculated by this method are lower than the maximum pressures used in our PCT apparatus. Therefore, the calculations from both methods show consistent results: in the electrochemical environment, higher storage capacity was obtained due to the reduction in equilibrium hydrogen pressure.

The OCV increased with increasing V-context except for YC#08. The addition of V in the alloy is supposed to increase the stability of the hydride by increasing the size of the hydrogen occupation site and decreasing the electronegativity. In this case, however, the equivalent hydrogen pressure increases (less stable hydride) with the increase in the V-content. One possible explanation is due to the reduction in synergetic effect from the reduced secondary phase amount as the V-content increased.

The half-cell HRD of each alloy, defined as the ratio of the discharge capacity measured at 50 mA g⁻¹ to that measured at 4 mA g⁻¹, at the 10^{th} cycle are also listed in Table 9. HRD increased as the V-content in the alloy increased. This is interesting since it is known that the secondary phases are crucial for the HRD in AB₂ MH alloys. In the current research, as the V-content increased, the abundance of secondary phases decreases, but the HRD increases. The major differences between the secondary phases in AB₂ alloys and Zr₂Ni₇ MH alloys are the abundance and distribution thereof. The secondary phases (mainly Zr₇Ni₁₀ and Zr₉Ni₁₁) in AB₂ MH alloy are less abundant and more finely distributed, which causes less resistance to hydrogen diffusion in the bulk.

Both the bulk diffusion coefficient (D) and the surface exchange current (Iₒ) were measured to dissociate the origin of the increase in HRD with V-content. The details of both parameters' measurements are known in the art, and the values are listed in Table 29. The D values increased with increasing V-content, which agrees with the HRD results. These D values are similar to those obtained from the ZrVₓNi_{4.5-x} alloys of example 1 above and are much higher than those measured in other MH alloy systems, such as AB₂ (9.7×10⁻¹¹ cm² s⁻¹), AB₅ (2.55×10⁻¹⁰ cm² s⁻¹), La-A₂B₇ (3.08×10⁻¹⁰ cm² s⁻¹), and Nd-A₂B₇ (1.14×10⁻¹⁰ cm² s⁻¹). In contrast with the D values, decreased with increasing V-content. These Iₒ are lower other MH alloys such as AB₂, A₂B₇, and AB₅ MH alloys. Further improvement in the surface reaction needs to be performed with substitutions that will increase the surface area and/or catalytic properties.

While not wishing to be bound by theory, the inventors believe that the secondary phases in the present alloys act as catalysts to reduce the hydrogen equilibrium pressure in the electrochemical environment and increase the storage capacity. Alloys with high abundance of secondary phase generally suffer from relatively low high-rate dischargeability, which is controlled mainly by the bulk diffusion.

The foregoing is provided for purposes of explaining and disclosing preferred embodiments of the present invention. Modifications and adaptations to the described embodiments, particularly involving changes to the alloy composition and components thereof will be apparent to those skilled in the art. These changes and others may be made without departing from the scope or spirit of the invention in the following claims.

We claim:

1. A hydrogen storage alloy, wherein said alloy has a higher electrochemical hydrogen storage capacity than that predicted by the alloy's gaseous hydrogen storage capacity at 2 MPa.

2. The hydrogen storage alloy of claim 1, wherein said hydrogen storage alloy has an electrochemical hydrogen storage capacity 5 to 15 times higher than that predicted by the maximum gaseous phase hydrogen storage capacity thereof.

3. The hydrogen storage alloy of claim 1, wherein said hydrogen storage alloy is selected from alloys of the group consisting of A₂B, AB, AB₂, AB₃, A₂B₇, AB₅ and AB₉.

4. The hydrogen storage alloy of claim 1, wherein said hydrogen storage alloy is selected from the group consisting of:
a) Zr(VₓNi_{4.5-x}); wherein 0<x≦0.5; and
b) Zr(VₓNi_{3.5-x}); wherein 0<x≦0.9.

5. The hydrogen storage alloy of claim 4, wherein said hydrogen storage alloy is Zr(VₓNi_{4.5-x}) and wherein 0<x≦0.5

6. The hydrogen storage alloy of claim 5, wherein 0.1≦x≦0.5.

7. The hydrogen storage alloy of claim 5, wherein 0.1≦x≦0.3.

8. The hydrogen storage alloy of claim 5, wherein 0.3≦x≦0.5.

9. The hydrogen storage alloy of claim 5, wherein 0.2≦x≦0.4.

10. The hydrogen storage alloy of claim 5, wherein x=0.1.

11. The hydrogen storage alloy of claim 5, wherein x=0.2.

12. The hydrogen storage alloy of claim 5, wherein x=0.3.

13. The hydrogen storage alloy of claim 5, wherein x=0.4.

14. The hydrogen storage alloy of claim 5, wherein x=0.5.

15. The hydrogen storage alloy of claim 4, wherein said hydrogen storage alloy further includes one or more elements selected from the group consisting Mn, Al, Co, and Sn in an amount sufficient enough to enhance one or both of the discharge capacity and the surface exchange current density versus the base alloy.

16. The hydrogen storage alloy of claim 5, wherein the bulk proton diffusion coefficient of said hydrogen storage alloy is greater than 4×10⁻¹⁰ _{cm}² s⁻¹.

17. The hydrogen storage alloy of claim 5, wherein said hydrogen storage alloy has a high rate dischargeability of at least 75%.

18. The hydrogen storage alloy of claim 5, wherein said hydrogen storage alloy has an open circuit voltage of at least 1.25 volts.

19. The hydrogen storage alloy of claim 5, wherein said hydrogen storage alloy has an exchange current of at least 24 mA g⁻¹.

20. A negative electrode for use in a Ni-metal hydride battery, said negative electrode including a hydrogen storage alloy having a higher electrochemical hydrogen storage capacity than that predicted by the alloy's gaseous hydrogen storage capacity at 2 MPa.

21. The negative electrode of claim 20, wherein said hydrogen storage alloy has an electrochemical hydrogen storage capacity 5 to 15 times higher than that predicted by the maximum gaseous phase hydrogen storage capacity thereof.

22. The negative electrode of claim 20, wherein said hydrogen storage alloy is selected from alloys of the group consisting of A₂B, AB, AB₂, AB₃, A₂B₇, AB₅ and AB₉.

23. The negative electrode of claim 20, wherein said hydrogen storage alloy is selected from the group consisting of:
a) Zr(VₓNi_{4.5-x}); wherein 0<x≦0.5; and
b) Zr(VₓNi_{3.5-x}); wherein 0<x≦0.9.

24. A Ni-metal hydride battery having a negative electrode including a hydrogen storage alloy having a higher electrochemical hydrogen storage capacity than that predicted by the alloy's gaseous hydrogen storage capacity at 2 MPa.

25. The Ni-metal hydride battery of claim 24, wherein said hydrogen storage alloy has an electrochemical hydrogen storage capacity 5 to 15 times higher than that predicted by the maximum gaseous phase hydrogen storage capacity thereof.

26. The Ni-metal hydride battery of claim 24, wherein said hydrogen storage alloy is selected from alloys of the group consisting of A₂B, AB, AB₂, AB₃, A₂B₇, AB₅ and AB₉.

27. The Ni-metal hydride battery of claim 24, wherein said hydrogen storage alloy is selected from the group consisting of:
a) Zr(VₓNi_{4.5-x}); wherein 0<x≦0.5; and
b) Zr(VₓNi_{3.5-x}); wherein 0<x≦0.9.
